(19) United States
(12) Patent Application Publication
(10) Pub. No.: US 2026/0250430 A1
(43) Pub. Date: Aug. 27, 2026

(54) HIGH MELT STRENGTH POLYPROPYLENE

(71) Applicant: BOREALIS GMBH, Vienna (AT)

(72) Inventor: Norbert Reichelt, Linz (AT)

(21) Appl. No.: 19/163,157

(22) PCT Filed: Mar. 13, 2024
(86) PCT No.: PCT/EP2024/056674

§ 371 Date: Sep. 8, 2025

(30) Foreign Application Priority Data
Mar. 13, 2023 (EP) 23 161 514.7

(51) Int. Cl. C08F 2/54; C08F 255/02

(52) U.S. Cl. CPC C08F 2/54; C08F 255/02

(57) ABSTRACT

The present invention is related to a process for a high melt strength polypropylene (HMS-PP), wherein the process comprises at least two electron beam irradiation periods, a high melt strength polypropylene (HMS-PP) obtainable by the inventive process, as well as an article comprising said high melt strength polypropylene (HMS-PP).

### TECHNICAL FIELD

The present invention is related to a process for producing a high melt strength polypropylene (HMS-PP), a high melt strength polypropylene (HMS-PP) obtained by said process, as well as an article comprising said high melt strength polypropylene (HMS-PP).

### TECHNICAL BACKGROUND

Propylene-based polymer compositions are versatile base materials that find application in a variety of areas, such as food packaging or automotive components.

In case propylene-based polymer compositions are applied to form shaped objects, it is necessary that the compositions have a sufficiently high melt strength to be able to mould the compositions into the desired shape. This is for example the case when propylene-based polymer compositions are shaped into objects via processes in which the composition is heated to above its melt temperature and subsequently shaped into the desired objects. In such processes, a high shape stability is required of the propylene-based polymer composition at the temperature at which the object is shaped. The propylene-based polymer composition needs to be able to maintain its shape in the molten situation under such temperature conditions prior to solidification by cooling taking place.

The melt strength represents an indication of the extent to which the individual polymeric molecules manage to maintain their positions towards each other (molecular entanglement) under conditions where the polymer composition is in a molten state. In particular, it can be described as the resistance of the polymer melt to stretching and untangling under strain.

Linear polypropylenes having a backbone without or with just a small number of sidechains are relatively easily untangled as little to no options are available for the polymer chains to be tangled with each other.

Branched polypropylenes on the other hand show significantly higher melt strength due to the entanglement of the main polymer chains and sidechains with each other, which is the reason they are labelled as high melt strength polypropylenes (HMS-PP).

Especially long chain branching substantially modifies the rheological behavior of the polypropylene, for example the elongational and shear viscosity.

A high melt strength provides beneficial characteristics to the product such as improved elasticity and good mechanical properties, which results in better process ability for example in extrusion, blow moulding, foaming, and thermoforming. Coupled with the mechanical properties and chemical resistance of standard polypropylene, this also allows entry into non-traditional polypropylene applications.

While the applications of high melt strength polypropylenes are widespread, there are still several drawbacks present in the known preparation processes.

Several pathways have been explored to obtain branched polypropylenes. Three main routes that are known to produce branched polypropylenes are:
A. Irradiation of polypropylene with or without coupling agents;
B. Reactive extrusion of polypropylene using a low temperature peroxide/peroxicarbonate alone or in combination with a coupling agent;
C. Polymerization of propylene and oligomers using special catalysts.

Routes A and B rely on the formation of radicals, either produced by a high energy beam or by peroxide reagents respectively, for the branching reaction.

The usage of peroxides on an industrial scale requires an increased level of security measures as they are highly reactive and can lead to highly exothermic, explosion-like reactions when handled improperly.

The drawbacks of route C originate from the special catalyst and special polymerization conditions required as well as small production volumes compared to typical size of commercial polymerization reactors.

Route A is the most preferred route in respect of product purity but securing the product quality in irradiation processes is challenging, as the active macroradicals tend to start visbreaking reactions.

The production of high melt strength polypropylenes by irradiating linear polypropylene with an electron beam in order to form macroradicals that lead to long chain branching of the linear polypropylene is known in the art.

Thereby an electron beam having a specific energy depending on the acceleration voltage of the used electron accelerator is applied to the polypropylene. The amount of energy transferred to the polypropylene (i.e. absorbed by the polypropylene) determines the amount of radicals formed and is typically described in the unit Gray, which corresponds to the absorption of one joule of radiation energy per kilogram of matter.

EP 0190889 discloses a process to produce branched polypropylene by irradiation of polypropylene flakes under reduced oxygen in presence of low level of antioxidants without a coupling agent. The radiation dose range is disclosed as being from 0.1 to 1000 kGy/min and it is disclosed that the ionizing radiation should have sufficient energy to penetrate to the extent desired in the mass of linear propylene polymer material being radiated. There is also disclosed the use of an accelerating potential (for an electron generator) of 500 to 4000 kV and radiation dose of 10 to 90 kGy. Following the irradiation step the irradiated material is heated in an extruder to deactivate the macroradicals.

Methods with additional crosslinking or branching agents are also known.

WO 01/88001 discloses a process to prepare branched polypropylene by irradiation in presence of crosslinking promoting gas such as butadiene and acetylene.

EP 1187860 discloses a process for the preparation of high melt strength polypropylene by irradiation of the polypropylene with a radiation dose of from 5 to 100 kGy with an electron beam having an acceleration voltage >5 MeV in presence of branching agents such as acrylates, diacrylates, butadiene and tetravinylsilane.

EP 1170306 discloses a process for irradiating polypropylene which has been polymerized using a Ziegler-Natta catalyst with an electron beam having an energy of at least 5 MeV and a radiation dose of at least 10 kGy and mechanically processing a melt of the irradiated polypropylene to form long chain branches on the polypropylene molecules.

WO 2018/028922 discloses a process to produce polypropylene with high melt strength by irradiation of polypropylene pellets containing only Vitamin E.

EP 0678527 discloses a process for producing a modified polypropylene in which polypropylene and a crosslinking agent mixture are irradiated with ionizing radiation so as to give an absorbed dosage of 1 to 20 kGy, with subsequent heat treating of the resultant material.

It is further known that when irradiating isotactic polypropylene, which has been produced using conventional Ziegler-Natta catalysts, the irradiation of the polypropylene with an electron beam produces free macroradicals and there is a competition between chain scission and branching depending on the absorbed radiation dosage and temperature.

Multiple unsaturated branching agents have been disclosed for polypropylene to reach the required level of branching without formation of gels at low dose.

These substances are employed to stabilize the macroradicals formed by abstraction of hydrogen from the polypropylene chain by high energy irradiation to form a branched structure by combination. Typical branching agents are very reactive unsaturated chemical compounds such as acrylates, di- and tri-acrylates, conjugated dienes such as butadiene, acetylene or vinyl compounds such as tetra vinylsilane or divinylbenzol.

The use of branching (or grafting or sensitizing) agents commonly leads to the disadvantage of unpleasant smell, increased cost and increased possibility of environmental problems, in particular toxicity, as a result of unreacted branching or grafting agent in the modified polypropylene. Another common problem of all these proposed substances is a potential migration of unreacted branching agent out of the polymer into the environment.

Preferably, all substances (branching agent and antioxidants) used in the polypropylene composition should originate from a renewable source and should generally be recognized as safe (GRAS) or food approved to be used in polypropylene compositions, as food packaging is one of the main applications for branched polypropylene.

The present invention aims to provide a process for obtaining polypropylene resins, having improved properties, in particular improved melt strength, which can be manufactured at a high production rate, optionally using a branching agent.

During extensive studies in this area it was surprisingly found, that a process comprising at least two irradiation periods instead of only one irradiation period as known in the art leads to improved properties due to increased branching of the obtained high melt strength polypropylenes, like higher melt strength and shear hardening index while applying the same total amount of radiation dose as in the known one step methods without interruption of the ionizing energy.

### SUMMARY OF THE INVENTION

Accordingly, the present invention is directed to a process for the preparation of a high melt strength polypropylene (HMS-PP), comprising steps in the following order:
a) providing a linear propylene polymer (L-PP), preferably a linear propylene homopolymer (H-PP), and
a1) optionally blending said propylene polymer (L-PP) with a coupling agent (CA) comprising a polyunsaturated organic compound, preferably a polyunsaturated fatty acid, and
b) irradiating the linear propylene polymer (L-PP) provided in step a) or the blend obtained in step a1) by means of electron beam irradiation,
wherein step b) comprises at least two irradiation periods, and
wherein between each irradiation period is a period of no irradiation, and
wherein each period of no irradiation is in the range of 0.01 min to 20 min, preferably 1.0 min to 20 min, more preferably 2.0 min to 20 min.

Further, the present invention is directed to a high melt strength polypropylene (HMS-PP) obtainable from said process.

Finally, the present invention is directed to an article, comprising the high melt strength polypropylene (HMS-PP) as described above.

### DETAILED DESCRIPTION OF THE INVENTION

Preferred embodiments of the invention are described in the dependent claims. In the following, the present invention is described in more detail.

Linear propylene polymer (L-PP)

The linear propylene polymer (L-PP) applied in the present invention can be a homopolymer or a copolymer of propylene.

The term “linear” with regard to the propylene polymer means, that branching in the polymer is low. In particular, it is preferred that the amount of branching in the linear propylene polymer (L-PP) is in the range from 0 to 10 branches/1000 carbon atoms, more preferably in the range from 0 to 5 branches/1000 carbon atoms, still more preferably in the range from 1 to 5 branches/1000 carbon atoms.

Polypropylene compositions consisting of a linear propylene homopolymer or a linear propylene copolymer are known.

A linear propylene homopolymer is obtained by polymerizing propylene under suitable polymerization conditions. A linear propylene copolymer is obtained by copolymerizing propylene with one or more other olefins, preferably ethylene, under suitable polymerization conditions.

The preparation of propylene homopolymers and copolymers is, for example, described in Moore, E. P. (996) Polypropylene Handbook. Polymerization, Characterization, Properties, Processing, Applications, Hanser Publishers; New York.

With polypropylene as used herein is meant propylene homopolymer or a copolymer of propylene with an α-olefin, for example an α-olefin chosen from the group of α-olefins having 2 or 4 to 10 C-atoms, preferably ethylene, wherein the amount of α-olefin, like ethylene, is preferably less than 10 wt % based on the total propylene copolymer.

Polypropylene and a copolymer of propylene with an α-olefin can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems.

Preferably, the linear propylene polymer (L-PP) has a melt flow rate MFR₂ (230° C., 2.16 kg) determined according to ISO 1133 in the range of 0.1 to 100 g/10 min, more preferably in the range of 0.2 to 50 g/10 min, still more preferably in the range of 0.5 to 10.0 g/10 min.

The linear propylene polymer (L-PP) can be a copolymer or a homopolymer of propylene, the latter being preferred. Moreover, the linear propylene polymer (L-PP) can comprise one or more linear propylene polymer (L-PP) components, which are different.

In case the linear propylene polymer (L-PP) is a copolymer of propylene, it is preferred that the linear propylene polymer (L-PP) has a comonomer content, like ethylene content, in the range of 0.2 to 25.0 mol %, more preferably in the range of 0.5 to 20.0 mol %, still more preferably in the range of 2.0 to 15.0 mol %, like in the range of 6.0 to 12.0 mol %.

It is preferred that the comonomer is selected from ethylene and/or C4 to C8 α-olefins. It is especially preferred that the comonomer is ethylene. For linear propylene polymers (L-PP) comprising more than one, like two different propylene polymer components, which are copolymers of propylene, it is preferred that all propylene polymer components contain the same comonomer, like ethylene.

Preferably the propylene polymer (PP), like the propylene homopolymer (H-PP), is isotactic. Accordingly, it is preferred that the propylene polymer (PP), like the propylene homopolymer (H-PP), has a rather high pentad concentration (mmmm %), i.e. more than 94.1%, more preferably more than 94.4%, like more than 94.4 to 98.5%, still more preferably at least 94.7%, like in the range of 94.7 to 97.5%.

According to a preferred embodiment of the present invention, the linear propylene polymer (L-PP) is a linear propylene homopolymer (H-PP).

According to the present invention the expression “propylene homopolymer” relates to a polypropylene that consists substantially, i.e. of at least 99.0 wt %, more preferably of at least 99.5 wt %, still more preferably of at least 99.8 wt %, like of at least 99.9 wt %, of propylene units. In another embodiment only propylene units are detectable, i.e. only propylene has been polymerized.

### Optional Coupling Agent (CA) Comprising a Polyunsaturated Organic Compound

Optionally, the inventive process can comprise a step a1), wherein step a1) comprises blending the linear propylene polymer (L-PP) with a coupling agent (CA) comprising a polyunsaturated organic compound.

As used herein, the term “polyunsaturated organic compound” refers to an organic compound having at least two carbon-carbon double bonds.

The following embodiments refer to embodiments of the inventive process comprising step a1).

The mixture obtained in step a1) of the inventive process preferably comprises 0.01 wt % to 5.0 wt %, more preferably 0.1 to 2.0 wt % of the coupling agent (CA) comprising a polyunsaturated organic compound, based on the overall weight of the mixture obtained in step a1).

Preferably, the amount of polyunsaturated organic compound in the coupling agent (CA) comprising a polyunsaturated organic compound is in the range of 20 wt % to 100 wt %, preferably 30 wt % to 90 wt %, more preferably 40 wt % to 80 wt %.

The polyunsaturated organic compound can be for example a polyunsaturated terpene, a diene, or a polyunsaturated fatty acid.

Polyunsaturated terpenes are for example squalene, geraniol, nerol, and linalool.

Dienes are for example butadiene, 1,7-octadiene, 1, 9-decadiene, 1,13-tetradecadiene, 1,8-nonadiene, 1,10-undecadiene, 1,11-dodecadiene, 1,15-hexadecadiene, 1,17-octadecadiene and norbornadiene.

Polyunsaturated fatty acids are for example linoleic acid, eicosadienoic acid, docosadienoic acid, α-linolenic acid, γ-linolenic acid, pinolenic acid, eleostearic acid, mead acid, dihomo-γ-linolenic acid, eicosatrienoic acid, stearidonic acid, arachidonic acid, eicosatetraenoic acid, adrenic acid, bosseopentaenoic acid, ozubondo acid, sardine acid, tetracosanolpentaenoic acid, cervonic acid and herring acid.

Preferably, the Coupling agent (CA) comprising a polyunsaturated organic compound comprises a bifunctional, polyunsaturated organic compound, i.e. an organic compound having a further functional group besides the carbon-carbon double bonds, e.g. a polyunsaturated fatty acid.

Preferably, the polyunsaturated organic compound is a polyunsaturated fatty acid, especially a polyunsaturated fatty acid selected from the group consisting of linoleic acid, eicosadienoic acid, docosadienoic acid, α-linolenic acid, γ-linolenic acid, pinolenic acid, eleostearic acid, mead acid, dihomo-γ-linolenic acid, eicosatrienoic acid, stearidonic acid, arachidonic acid, eicosatetraenoic acid, adrenic acid, bosseopentaenoic acid, ozubondo acid, sardine acid, tetracosanolpentaenoic acid, cervonic acid and herring acid. The most preferred polyunsaturated fatty acid is linoleic acid and/or α-linolenic acid.

It is especially preferred that the Coupling agent (CA) comprising a polyunsaturated organic compound comprises linoleic acid and/or α-linolenic acid.

Preferably, the coupling agent (CA) is a natural source of polyunsaturated unsaturated fatty acids. In particular, it is preferred that the coupling agent (CA) is selected from the group consisting of linseed oil, walnut oil, tung oil and sunflower oil. Preferably the coupling agent (CA) is linseed oil, more preferably native linseed oil.

Linseed oil is distinctive for its unusually large amount of α-linolenic acid, which has a distinctive reaction with oxygen in air and therefore acts as stabilizer/radical scavenger for polypropylene and offers the combination of the highest content of polyunsaturated fatty acids with lowest level of saturation fatty acids available as commercial vegetable oils. The USFDA granted generally recognized as safe (GRAS) status for high α-linolenic flaxseed oil. Accordingly, the high melt strength polypropylene (HMS-PP) according to the present invention is suitable for the production of food containers and food-related products.

### Blend Between L-PP and CA

Blending techniques are known in the art, such as melt blending, dry blending and solution blending.

The linear propylene polymer (L-PP) is preferably melt blended, for example by extruding, or dry blended with the coupling agent (CA).

A peroxide can be added during melt blending to adjust the MFR by chemical visbreaking during the extrusion step.

The blend between the L-PP and the CA may further comprise an organometallic stearate selected from magnesium stearate, aluminum stearate, sodium stearate and calcium stearate. It is preferred that the blend comprises calcium stearate. The amount of the organometallic stearate, preferably calcium stearate, may range between 100 ppm and 1000 ppm by weight, more preferably between 200 ppm and 800 ppm by weight, still more preferably preferred between 400 ppm and 600 ppm by weight, based on the overall weight of the blend.

The blend between the L-PP and the CA may further comprise antioxidants and process stabilizer used for polypropylene in the industry in 2022.

Suitable antioxidants and process stabilizers are known to the person skilled in the art. For example, commercially available antioxidants and process stabilizers are described in “Plastic Additives Handbook”, 6th edition 2009 of Hans Zweifel (pages 1141 to 1190).

In one embodiment of the invention, the blend between the L-PP and the CA does not comprise antioxidants and/or process stabilizers.

In another embodiment of the invention, the blend between the L-PP and the CA comprises antioxidants in an amount in the range of 50 to 500 ppm, preferably 100 to 200 ppm, and/or process stabilizers in an amount in the range of 50 to 500 ppm, preferably 100 to 200 ppm, based on the total weight of the blend.

It is preferred to produce the blend on a twin screw extruder under nitrogen to prevent visbreaking reactions.

Preferably, the blend between L-PP and CA consists of an L-PP, as described above, and a CA, as described above, in a total amount in the range of 95.0 wt % to 100 wt %, preferably 97.0 wt % to 100 wt %, more preferably 99.0 wt % to 100 wt % based on the total weight of the blend.

### Electron Beam Irradiation

In order to initiate the radical formation and subsequent long chain branching the linear propylene polymer (L-PP), as described above, or the blend between the CA and the L-PP, as described above, is irradiated with an electron beam in step b) of the inventive process.

It was surprisingly found, that in a process, wherein the irradiation step b) comprises at least two irradiation periods, an improved high melt strength polypropylene (HMS-PP) can be obtained compared to a HMS-PP obtained from a process comprising just one irradiation period.

Irradiation of polymers by means of electron beam irradiation is known in the art. Typically, the amount of radiation applied to the respective sample matter is indicated by the unit Gray (Gy), which is the absorption of one joule of radiation energy per kilogram of matter.

Since the absorbed energy at different depths of the matter varies, the radiation doses given in this disclosure refer to the amount of energy that is applied to the surface of the matter facing the electron beam per kilogram of the matter and are therefore described as “surface irradiation doses”.

According to the invention, partitioning the total surface radiation dose applied to the linear propylene polymer (L-PP) or to the blend of the linear propylene polymer and the coupling agent into at least two irradiation periods, leads to an HMS-PP with improved characteristics, e.g. increased F₃₀ melt strength.

It is thereby preferred that the applied surface radiation dose in the first of the at least two irradiation periods is in the range of 10 to 150 kGy, preferably 50 kGy to 130 kGy, more preferably 60 kGy to 110 kGy.

Further, it is preferred that the applied surface radiation dose in the second of the at least two irradiation periods is in the range of 5 to 150 kGy, preferably 8 to 80 kGy, more preferably 10 to 50 kGy.

It is preferred, that the applied surface radiation dose in the second of the at least two irradiation periods is lower than the applied surface radiation dose in the first of the at least two irradiation periods.

Accordingly, the ratio between the applied surface radiation dose in the first of the at least two irradiation periods and the applied surface radiation dose in the second of the at least two irradiation periods is preferably in the range of more than 1.1 to 30, preferably 1.2 to 15, more preferably 1.5 to 8.0.

The inventive process may comprise more than two irradiation periods, like three, four or five, but it is preferred that the irradiation in step b) comprises two irradiation periods and no further irradiation periods.

Accordingly it is preferred that step b) consists of two irradiation periods and in between of a period of no irradiation, wherein the period of no irradiation is in the range of 0.01 min to 20 min, preferably 1.0 min to 20 min, more preferably 2.0 min to 20 min.

Just for clarification, the inventive process does not comprise further irradiation periods before or after step b).

The total applied radiation dose is the sum of the applied radiation doses in each irradiation period of step b). In a preferred embodiment of the invention, the total applied surface radiation dose in the process is in the range of 30 kGy to 200 kGy, preferably 50 kGy to 180 kGy, more preferably 60 kGy to 130 kGy.

Between each of the at least two irradiation periods is a period of no irradiation and each period of no irradiation is in the range of more than 0.01 min to 20 min, preferably 1.0 min to 20 min, more preferably 2.0 min to 20 min, even more preferably 4.0 min to 12 min.

### Process Parameters

Methods to produce electron beams and apply radiation doses are known in the art. Further it is well known, that the acceleration voltage and beam current of the used electron beam producing device have a direct influence on the penetration depth and transferable energy of the electron beam.

According to the inventive process, it is preferred that the electron beam is produced with an acceleration voltage in the range of 5 MeV to 15 MeV, preferably 7 MeV to 13 MeV, more preferably 8 MeV to 12 MeV.

In order to transfer the energy (corresponds to the surface radiation dose) of the electron beam onto the respective matter, the matter has to be subjected to the electron beam.

This can be done, for example, by using a moving belt that passes underneath the electron beam, thereby subjecting the L-PP provided in step a) or the blend obtained in step a1), which is applied onto the belt, to the electron beam.

The parameters that need to be adjusted in order to apply a specific radiation dose are known to the person skilled in the art.

For example, a higher belt speed of the moving belt decreases the contact time of the electron beam with the matter to be irradiated and consequently lowers the applied surface radiation dose.

Other parameters influencing the applied surface dose are the quality of the electron beam focus, the dimension of the electron beam and the distance of the matter to the horn of the electron beam generating device.

Focused electron beams have a dimension of about 100×10 mm in close distance to the horn. The width of beam at the surface of the matter and resulting contact time depend on distance to horn and quality of e-beam focus.

Accordingly, the contact time t per irradiation period can be calculated by dividing the width of the electron beam at the surface (mm) by the belt speed (mm/s).

The belt speed depends on the required surface dose and on the energy (kWh) emitted from accelerator. Typical contact time for PP pellets placed a moving belt irradiated with 200 kWh/h operated at 190 kW output power are <2 seconds, assuming an electron beam with dimensions of 100×10 mm width.

### Containment

The irradiation in step b) can be performed in an inert or in a non-inert environment. Preferably, step b) is carried out in an inert atmosphere on a moving belt. In particular, it is preferred that the irradiation is carried out under nitrogen.

In order to control the gaseous environment, the L-PP provided in step a) or the blend obtained in step a1) can be placed inside a sealable containment before irradiating in step b).

The term “sealable” refers to the condition, that one gaseous environment (e.g. in a containment) can be separated from another gaseous environment (outside the containment) in order to avoid any substantial gas exchange between the two gaseous environments.

The form of the sealable containment is not limited to any specific form. The sealable containment can be a container, an airtight room, or a mixer, such as a fluidized bed reactor or stirred tank reactor.

The form of the container can be selected for example from a cubical, cuboidal or cylindrical form, preferably the sealable container is in a cylindrical form.

In order to avoid unwanted side reactions, such as uncontrolled peroxide formation by the oxygen in the air, the sealable containment containing the L-PP provided in step a) or the blend obtained in step a1) can be flushed with nitrogen until an atmosphere having oxygen in an amount in the range of 1 to 1000 ppm, preferably 50 to 400 ppm, more preferably 100 to 300 ppm inside the containment is reached.

During the irradiation and consequent radical reaction, hydrogen gas is produced. Hydrogen gas is a risk for explosions but supports the formation of long chain branches in PP.

The containment or the reactor vessel can be used to collect hydrogen for further use as energy production and to create a reaction environment that supports the formation of long chain branches by increased partial pressure of hydrogen during irradiation process and following steps until all radicals are deactivated.

In one embodiment of the invention, it is preferred that the maximum (over)pressure in the process does not exceed 0.2 bar. Accordingly, the pressure during the process is preferably in the range of 0.0 to 0.2 bar.

To secure that the maximum pressure inside the containment is under 0.2 bar, a sealable containment comprising a safety valve that releases excess gas when the interior pressure reaches a level over the selected threshold can be used.

In another embodiment of the invention, it is preferred that the (over)pressure during the process is more than 0.2 bar, in particular in a range of more than 0.2 bar to 2 bar.

### Further Processing

The irradiated L-PP or irradiated blend obtained after step b) contains reactive radicals. In order to complete the branching reaction and deactivate the majority of radicals, the inventive process may comprise after step b) a further step c), wherein step c) comprises a tempering period, where the irradiated L-PP or irradiated blend obtained in step b) is tempered at a temperature in the range of 40 to 140° C., preferably 50° C. to 70° C.

Tempering in this disclosure is to be understood as a heat treatment.

Further it is preferred, that the tempering period in step c) is in the range of 5 min to 120 min, preferably 45 min to 90 min.

Due to the difference of absorbed energy depending on the depth of the irradiated matter, a mixture of non- or less-modified PP and modified PP is obtained after step b) or step c).

In order to homogenize the obtained PP mixture, the inventive process may comprise a further step d), wherein step d) comprises homogenization of the irradiated L-PP or irradiated blend obtained after step b) or step c).

Techniques for the homogenization are known to the person skilled in the art. For example, the irradiated L-PP or irradiated blend obtained after step b) or step c) can be homogenized by extrusion.

Step d) can further be utilized to compound or blend the obtained HMS-PP with additives (AD) to achieve beneficial properties.

It is preferred that irradiated product from step b) or c) does not get in contact with oxygen before or during the addition of additives in step d).

Suitable additives (AD) are nucleating agents and clarifiers, stabilizers, release agents, fillers, peroxides, plasticizers, anti-oxidants, lubricants, antistatics, scratch resistance agents, high performance fillers, pigments and/or colorants, impact modifiers, flame retardants, blowing agents, acid scavengers, recycling additives, coupling agents, anti-microbials, anti-fogging additives, slip agents, anti-blocking additives, polymer processing aids and the like. Such additives are commercially available and for example described in “Plastic Additives Handbook”, 6th edition 2009 of Hans Zweifel (pages 1141 to 1190). Preferably, the additives (AD) are selected from the group consisting of anti-oxidants, process stabilizers, or mixtures thereof.

The term “additives (AD)” according to the present invention also includes carrier materials, in particular polymeric carrier materials.

Instead or in addition to adding the additives (AD) in step d) to the irradiated L-PP or irradiated blend obtained after step b) or step c), the additives (AD) can be applied to the surface of the homogenized irradiated L-PP or homogenized irradiated blend in order to achieve a cost and energy effective surface stabilization.

In a preferred embodiment of the invention, the inventive process comprises the following steps:
a) providing a linear propylene polymer (L-PP), preferably a linear propylene homopolymer (H-PP), and
a1) blending said propylene polymer (L-PP) with a coupling agent (CA) comprising a polyunsaturated fatty acid, and
b) irradiating the blend obtained in step a1) by means of electron beam irradiation, and
c) tempering the irradiated blend obtained in step b) at a temperature in the range of 50° C. to 70° C., and
d) homogenizing the irradiated blend obtained in step c),
wherein step b) comprises, preferably consists of, two irradiation periods and one period of no irradiation between the two irradiation periods,
wherein the applied surface radiation dose in the first irradiation period is in the range of 60 kGy to 110 kGy, and
wherein the applied surface radiation dose in the second irradiation period is in the range of 10 kGy to 50 kGy, and
wherein the period of no irradiation between the two irradiation periods is in the range of 2 min to 20 min, and
wherein the tempering period in step c) is in the range of 45 min to 90 min.

### HMS-PP

A high melt strength polypropylene (HMS-PP) according to this disclosure has an additional F₃₀ melt strength (AMS) of ≥5 cN, determined according to ISO 16790:2005, compared to the F₃₀ melt strength (LMS) of a linear polypropylene having the same melt flow rate MFR₂.

The present invention provides a process to manufacture such high melt strength polypropylene HMS-PP.

In particular, the inventive process can be used to produce a high melt strength polypropylene (HMS-PP) having the following characteristics.

A high melt strength polypropylene (HMS-PP) comprising units derivable from:
i) propylene, and
ii) at least one polyunsaturated fatty acid,
wherein the high melt strength polypropylene (HMS-PP) has a crystallization temperature Tc determined according to DSC of more than 120° C., preferably in the range of 120° C. to 132° C., and
wherein the F₃₀ melt strength by Rheotens measurement according to ISO 16790:2005 at 200° C., acceleration of 120 mm/s, at standard shear (die pressure 30 bar) is more than 26 cN, preferably in the range of more than 26 cN to 50 cN,
the melt flow rate MFR₂ (230° C., 2.16 kg) determined according to ISO 1133 is in the range of 1.0 to 2.4 g/10 min, and wherein
the complex shear viscosity η* at a frequency of 285 rad/s, determined by dynamic shear measurements complying with ISO standards 6721-1 and 6721-10, is more than 170 Pa s, preferably in the range of more than 170 Pa s to 220 Pa s.

Preferably, the units derivable from at least one polyunsaturated fatty acid are from linseed oil. The linseed oil is thereby the Coupling agent (CA) comprising a polyunsaturated organic compound in the process for producing the high melt strength polypropylene (HMS-PP).

Lastly, the invention relates to foamed objects or articles which are produced using the high melt strength polypropylene (HMS-PP) according to the present invention.

The present invention is further directed to an article, comprising the high melt strength polypropylene (HMS-PP). Preferably, the article comprises at least 80 wt %, more preferably at least 90 wt %, still more preferably at least 95 wt %, like at least 99 wt % of the high melt strength polypropylene (HMS-PP), based on the overall weight of the article. It is especially preferred that the article consists of the high melt strength polypropylene (HMS-PP).

The article is preferably a foamed article, more preferably an extrusion foam article, foam injection moulded article or pearl foam article, injection blow moulded article or a blown film.

Preferably, the article is a foamed article, an injection blow moulded article or a blown film. It is especially preferred that the article is a foamed article such as an extrusion foam article, foam injection moulded article or particle foam article.

The high melt strength polypropylene (HMS-PP) according to the invention may be formed into foam structures by a melt processing step. Such melt processing step may be performed in melt extruder. A blowing agent may be added to the melt processing to induce the formation of foam cells. Such blowing agent may be a chemical blowing agent or a physical blowing agent. The chemical blowing agent may for example be selected from sodium hydrogen carbonate, citric acid derivatives, azodicarbonamide, hydrazodicarbonamide, 4,4′-oxybis (benzenesulfonyl hydrazide), N, N-dinitroso pentamethylene tetramine, 5-phenyltetrazole, p-Toluene sulfonyl hydrazide, and/or p-toluene sulphonylsemicarbazide. The physical blowing agent may for example be selected from nitrogen, carbon dioxide, isobutane, pentane and cyclopentane. Preferably, the blowing agent is isobutane.

The blowing agent may be introduced into the extruder at a location where the high melt strength polypropylene (HMS-PP) according to the invention is in a molten state. For example, it is preferred that the blowing agent is introduced in quantities in the range of 1.0 to 20.0 wt %, more preferably in the range of 1.5 to below 10.0 wt %, still more preferably in the range of 2.0 to 5.0 wt %, based on the overall weight of the high melt strength polypropylene (HMS-PP). The introduction of such quantities of blowing agent may contribute to the formation of a foamed structure having a desired low density in combination with a desired high fraction of closed cells. It is preferred that 2.0 to below 10.0 wt %, more preferably more than 2.0 to 5.0 wt % of isobutene, based on the overall weight of the high melt strength polypropylene (HMS-PP), is used as blowing agent.

In addition, further commonly known additives suitable for the production of foam structures from propylene-based polymer compositions may be used. For example, a quantity of a nucleating agent such as talc and/or fatty acid (bis)amides may be added. Preferably, talc is used as nucleating agent. For example, it is preferred that the nucleating agent is added in quantities of 0.1 to 2.0 wt %, more preferably 0.5 to 1.5 wt %, based on the overall weight of the high melt strength polypropylene (HMS-PP).

Also, a quantity of a cell stabilizer such as glycerol monostearate (GMS), glycerol monopalmitate (GMP), glycol di-stearate (GDS), palmitides and/or amides for example stearyl stearamide, palmitamide and/or stearamide may be added.

Preferably, glycerol monostearate is used as cell stabilizer. For example, it is preferred that the cell stabilizer is added in quantities of 0.1 to 2.0 wt %, more preferably 0.5 to 1.5 wt %, based on the overall weight of the high melt strength polypropylene (HMS-PP).

The high melt strength polypropylene (HMS-PP) may subsequently be extruded from a die outlet of the melt extruder. The foam structure may thus be formed.

The present invention also relates to foam produced with the high melt strength polypropylene (HMS-PP) obtained with the irradiation process according to the invention.

The density of the foam structures ranges between 20 and 800 kg/m³. The density of the foam structures was determined as the apparent overall density according to ISO 845 (2006). The fraction of closed cells is preferably equal or above 90%, more preferably equal or above 98%, still more preferably above 98%. The fraction of closed cells was determined by placing a sample of the foam having a known mass and a known density as determined as the apparent overall density according to ISO 845 (2008) in a desiccator. The samples each had a length of 5 cm and a width of 3 cm. The desiccator was filled with water and a polyethylene glycol as surfactant. The pressure in the desiccator was reduced to 500 mbar. The samples were kept under these conditions for 0 min, following which the objects via a melt extrusion foaming process using a propylene-based composition produced according to the process of the invention, wherein the foamability window is equal or above 5° C., the foamability window being defined as the temperature range where foams may be produced having an apparent overall density equal or below 175 kg/m³ as determined according to ISO 845 (2006) and a closed cell content equal or above 90% when using 2.3 wt % of isobutane as blowing agent.

Further the invention relates to the following numbered aspects.
1. A process for producing a high melt strength polypropylene (HMS-PP), comprising the following steps:
   a) providing a linear propylene polymer (L-PP), and
   b) irradiating the linear propylene polymer (L-PP) provided in step a) by means of electron beam irradiation,
   wherein step b) comprises at least two irradiation periods, and
   wherein between each irradiation period is a period of no irradiation, and
   wherein each period of no irradiation is in the range of more than 0.01 min to 20 min, preferably 1.0 min to 20 min, more preferably 2.0 min to 20 min.
2. The process according to aspect 1, wherein the high melt strength polypropylene (HMS-PP) has an additional F₃₀ melt strength (AMS) of ≥5 cN compared to the F₃₀ melt strength (LMS) of a linear polypropylene having the same melt flow rate MFR₂ (ISO 1133, 2.16 kg, 230° C.) as the high melt strength polypropylene (HMS-PP), calculated according to equation (II)

$$AMS = MS ( HMS - PP ) - LMS , \qquad ( II )$$

wherein AMS is the additional F₃₀ melt strength (AMS) determined according to ISO 16790:2005 compared to the F₃₀ melt strength (LMS) of a linear polypropylene having the same melt flow rate MFR₂ (230° C., 2.16 kg) determined according to ISO 1133 as the high melt strength polypropylene (HMS-PP) in [cN],
MS(HMS-PP) is the F₃₀ melt strength of the high melt strength polypropylene (HMS-PP) determined according to ISO 16790:2005 in [cN],
LMS is the F₃₀ melt strength (LMS) of a linear polypropylene having the same melt flow rate MFR₂ (230° C., 2.16 kg) determined according to ISO 1133 as the high melt strength polypropylene (HMS-PP) in [cN], and wherein the F₃₀ melt strength (LMS) of the corresponding linear polypropylene having the same melt flow rate MFR₂ as the high melt strength polypropylene (HMS-PP) and a polydispersity in the range of 3 to 5 is determined according to equation (III)

$$LMS = 17.35 {MFR}^{- 0.994} , \qquad ( III )$$

wherein MFR is the melt flow rate MFR₂ (230° C., 2.16 kg) determined according to ISO 1133 of the high melt strength polypropylene (HMS-PP).
3. The process according to any of the preceding aspects, comprising the following steps:
   a) providing a linear propylene homopolymer (H-PP), and
   b) irradiating the linear propylene homopolymer (H-PP) provided in step a) by means of electron beam irradiation,
   wherein step b) comprises at least two irradiation periods,
   between each irradiation period is a period of no irradiation, and
   wherein each period of no irradiation is in the range of more than 0.01 min to 20 min, preferably 1.0 min to 20 min, more preferably 2.0 min to 20 min.
4. The process according to any of the preceding aspects, comprising the following steps:
   a) providing a linear propylene polymer (L-PP),
   a1) blending the linear propylene polymer (L-PP) provided in step a) with a coupling agent (CA) comprising a polyunsaturated organic compound, and
   b) irradiating the blend obtained in step a1) by means of electron beam irradiation,
   wherein step b) comprises at least two irradiation periods, and
   wherein between each irradiation period is a period of no irradiation, and
   wherein each period of no irradiation is in the range of more than 0.01 min to 20 min, preferably 1.0 min to 20 min, more preferably 2.0 min to 20 min.
5. The process according to any of the preceding aspects, comprising the following steps:
   a) providing a linear propylene homopolymer (H-PP), and
   a1) blending said linear propylene homopolymer (H-PP) with a coupling agent (CA) comprising a polyunsaturated organic compound, and
   b) irradiating the blend obtained in step a1) by means of electron beam irradiation,
   wherein step b) comprises at least two irradiation periods, and
   wherein between each irradiation period is a period of no irradiation, and
   wherein each period of no irradiation is in the range of more than 0.01 min to 20 min, preferably 1.0 min to 20 min, more preferably 2.0 min to 20 min.
6. The process according to any of the preceding aspects, comprising the following steps:
   a) providing a linear propylene polymer (L-PP), and
   a1) blending said linear propylene polymer (L-PP) with a coupling agent (CA) comprising a polyunsaturated fatty acid, and
   b) irradiating the blend obtained in step a1) by means of electron beam irradiation,
   wherein step b) comprises at least two irradiation periods, between each irradiation period is a period of no irradiation, and
   wherein each period of no irradiation is in the range of more than 0.01 min to 20 min, preferably 1.0 min to 20 min, more preferably 2.0 min to 20 min.
7. The process according to any of the preceding aspects, comprising the following steps:
   a) providing a linear propylene homopolymer (H-PP), and
   a1) blending said linear propylene homopolymer (H-PP) with a coupling agent (CA) comprising a polyunsaturated fatty acid, and
   b) irradiating the blend obtained in step a1) by means of electron beam irradiation,
   wherein step b) comprises at least two irradiation periods, between each irradiation period is a period of no irradiation, and
   wherein each period of no irradiation is in the range of more than 0.01 min to 20 min, preferably 1.0 min to 20 min, more preferably 2.0 min to 20 min.
8. The process according to any of aspects 4 to 7, wherein the blend obtained in step a1) comprises 0.01 to 5.0 wt %, more preferably 0.1 to 2.0 wt % of the coupling agent (CA) comprising a polyunsaturated organic compound, based on the overall weight of the blend obtained in step a1).
9. The process according to any of aspects 4 to 8, wherein the amount of polyunsaturated organic compound in the coupling agent (CA) comprising a polyunsaturated organic compound is in the range of 20 wt % to 100 wt %, preferably 30 wt % to 90 wt %, more preferably 40 wt % to 80 wt %.
10. The process according to any of aspects 4 to 9, wherein the coupling agent (CA) comprising a polyunsaturated organic compound is selected from the group consisting of linseed oil, walnut oil, tung oil and sunflower oil, preferably is linseed oil, more preferably virgin linseed oil.
11. The process according to any of aspects 4 to 10, wherein the blend between the L-PP and the CA obtained in step a1) further comprises antioxidants in an amount in the range of 10 to 500 ppm, preferably 25 to 200 ppm based on the total weight of the blend, and/or process stabilizers each in an amount in the range of 10 to 500 ppm, preferably 25 to 200 ppm, based on the total weight of the blend.
12. The process according to any of the preceding aspects, wherein the maximum pressure in the process does not exceed 0.2 bar and is in the range of 0.0 to 0.2 bar.
13. The process according to any of aspects 1 to 11, wherein pressure in the process is more than 0.2 bar, preferably in the range of more than 0.2 bar to 2.0 bar.
14. The process according to any of the preceding aspects, wherein the process comprises after step b) a further step c), wherein step c) comprises a tempering period, where the irradiated mixture obtained in step b) is tempered at a temperature in the range of 40 to 140° C., preferably 50° C. to 70° C.
15. The process according to any of the preceding aspects, wherein the tempering period in step c) is in the range of 5 min to 120 min, preferably 45 min to 90 min.
16. The process according to any of the preceding aspects, wherein in step b) the applied surface radiation dose in the first of the at least two irradiation periods is in the range of 10 to 150 kGy, preferably 55 kGy to 130 kGy, more preferably 60 kGy to 110 kGy.
17. The process according to any of the preceding aspects, wherein in step b) the applied surface radiation dose in the second of the at least two irradiation periods is in the range of 5 to 150 kGy, preferably 8 to 80 kGy, more preferably 10 to 50 kGy.
18. The process according to any of the preceding aspects, wherein in step b) the ratio between the applied surface radiation dose in the first of the at least two irradiation periods and the applied surface radiation dose in the second of the at least two irradiation periods is in the range of more than 1.1 to 30, preferably 1.2 to 15, more preferably 1.5 to 8.0.
19. The process according to any of the preceding aspects, wherein the total applied surface radiation dose in the process is in the range of 30 kGy to 200 kGy, preferably 50 kGy to 180 kGy, more preferably 60 kGy to 130 kGy.
20. The process according to any of the preceding aspects, wherein the electron beam for the electron beam irradiation is an electron beam having an acceleration voltage in the range of 5 MeV to 15 MeV, preferably 7 MeV to 13 MeV, more preferably 8 MeV to 12 MeV.
21. The process according to any of the preceding aspects, wherein step b) consists of two irradiation periods and in between of a period of no irradiation wherein the period of no irradiation is in the range of 0.01 min to 20 min, preferably 1.0 min to 20 min, more preferably 2.0 min to 20 min.
22. The process according to any of the preceding aspects, comprising the following steps:
   a) providing a linear propylene polymer (L-PP), preferably a linear propylene homopolymer (H-PP), and
   a1) blending said propylene polymer (L-PP) with a coupling agent (CA) comprising a polyunsaturated organic compound, preferably a polyunsaturated fatty acid, and
   b) irradiating the blend obtained in step a1) by means of electron beam irradiation, and
   c) tempering the irradiated blend obtained in step b) at a temperature in the range of 50° C. to 70° C., and
   wherein step b) comprises, preferably consists of, two irradiation periods and one period of no irradiation between the two irradiation periods,
   wherein the applied surface radiation dose in the first irradiation period is in the range of 60 kGy to 110 kGy, and
   wherein the applied surface radiation dose in the second irradiation period is in the range of 10 kGy to 50 kGy, and
   wherein the period of no irradiation between the two irradiation periods is in the range of 2 min to 20 min, and
   wherein the tempering period in step c) is in the range of 45 min to 90 min.
23. The process according to any of the preceding aspects, wherein the linear polypropylene (L-PP) provided in step a) or the blend obtained in step a1) is placed inside a sealable containment before irradiating in step b).
24. The process according to aspect 23, wherein the sealable containment containing the linear polypropylene (L-PP) provided in step a) or the blend obtained in step a1) is flushed with nitrogen until an atmosphere having oxygen in an amount in the range of 1 to 1000 ppm, preferably 50 to 400 ppm, more preferably 100 to 300 ppm inside the containment is reached.
25. The process according to any of the preceding aspects, wherein the process comprises after step b) or step c) a further step d), wherein step d) comprises homogenizing the irradiated L-PP or the irradiated blend obtained in step b) or step c).
26. The process according to aspect 25, wherein additives (AD) can be added to the irradiated L-PP or irradiated blend obtained in step b) or step c) before or during the homogenization.
27. The process according to aspect 25, wherein additives (AD) are applied to the surface of the homogenized irradiated L-PP or homogenized irradiated blend.
28. A high melt strength polypropylene (HMS-PP) comprising units derivable from:
   i) propylene, and
   ii) at least one polyunsaturated fatty acid,
   wherein the high melt strength polypropylene (HMS-PP) has a crystallization temperature Tc determined according to DSC of more than 120° C., preferably in the range of 120° C. to 132° C., and
   wherein the F₃₀ melt strength by Rheotens measurement according to ISO 16790:2005 at 200° C., acceleration of 120 mm/s, at standard shear (die pressure 30 bar) is more than 26 cN, preferably in the range of more than 26 cN to 50 cN, the melt flow rate MFR₂ (230° C., 2.16 kg) determined according to ISO 1133 is in the range of 1.0 to 2.4 g/10 min, and wherein
   the complex shear viscosity η* at a frequency of 285 rad/s, determined by dynamic shear measurements complying with ISO standards 6721-1 and 6721-10, is more than 170 Pa s, preferably in the range of more than 170 Pa s to 220 Pa s.
29. The high melt strength polypropylene (HMS-PP) according to aspect 28, wherein the HMS-PP is obtained by the process according to any of aspects 1-27.
30. The high melt strength polypropylene (HMS-PP) according to aspect 28 or 29,
   wherein the units derivable from at least one polyunsaturated fatty acid are from linseed oil as the Coupling agent (CA) comprising a polyunsaturated organic compound.
31. An article comprising the high melt strength polypropylene (HMS-PP) according to any of aspects 28 to 30.
32. A use of the high melt strength polypropylene (HMS-PP) according to any of claims 28 to 30 for foam applications, preferably extrusion foam, bead foam, injection moulding foam or coating foam.

### EXAMPLES

### Measuring Methods

The following definitions of terms and determination methods apply for the above general description of the invention as well as to the below examples unless otherwise defined.

MFR₂ (230° C.) is measured according to ISO 1133 (230° C., 2.16 kg load).

### GPC Measurement

A gel permeation chromatograph (GPC) manufactured by PolymerChar (Valencia, Spain) equipped with an infra-red detector (IR5), an online four capillary bridge viscometer and a multi-angle light scattering (MALS) detector (Dawn Helios 2) with 18 angles ranging from around 22.5° to 147.0° from Wyatt technology (Santa Barabara, USA) was used. 3× Olexis and 1× Olexis Guard columns from Agilent as stationary phase and 1,2,4-trichlorobenzene (TCB, stabilized with 250 mg/L 2,6-Di tert butyl-4-methyl-phenol) as mobile phase at 160° C. and at a constant flow rate of 1 mL/min was applied. The polymer sample was dissolved at a concentration of 1 mg/ml at 160° C. for 150 min in TCB. 200 μl of the polymer solution were injected per analysis. The injected concentration of the polymer solution at 160° C. (c_{160° C.}) was determined in the following way.

### GPC-VISC-MALS

The IV detector was calibrated with NIST1475a using a nominal IV of 1.01 dl/g. The inter-detector volume between the different detectors, concentration (IR), LS and viscometer detector was achieved by analysing a narrow distributed PS standard having a molar mass of 30000 g/mol.

For the determination of MWD using GPC-VISC-MALS technique the normalisation of the different MALS angles was obtained with a narrow distributed PS standard having a molar mass of 30.000 g/mol. The MALS detector was calibrated with certified PE standard, NIST1475a with a Mw of 54.000 g/mol using a dn/dc of 0.094 ml/mg at a laser wavelength (k) of 660 nm. For calculation of the molecular weight, the laser wavelength (k) of 660 nm and a dn/dc of 0,094 ml/mg for the PP in TCB solution were used. Due to the higher baseline noise and frequent disturbances, the MALS signal of the smallest 3 angles were not used in all calculations. Because of the low sample concentration used, the second viral coefficient (A2=0) was neglected. The absolute Mw at each chromatographic slice and the corresponding radius of gyration (R_{g}) were obtained from the slope and the intercept of the Debye plot.ⁱ Zimm formulism was used for extrapolation of the corresponding Rayleigh ratios (R(Θ)) of the different angles.

Molecular weight averages (Mz(LS), Mw(LS) and Mn(LS)), Molecular weight distribution (MWD) and its broadness, described by polydispersity, PD(LS)=Mw(LS)/Mn(LS) (wherein Mn(LS) is the number average molecular weight and Mw(LS) is the weight average molecular weight obtained from GPC-LS) were calculated by Gel Permeation Chromatography (GPC) using the following formulas:

$${M}_{n} ( LS ) = \frac{{\sum }_{i = 1}^{N} {A}_{i}}{\sum ( {A}_{i} / {M}_{i ( LS )} )}$$

$${M}_{w} ( LS ) = \frac{{\sum }_{i = 1}^{N} ( {A}_{i} \times {M}_{i ( LS )} )}{\sum {A}_{i}}$$

$${M}_{z} ( LS ) = \frac{{\sum }_{i = 1}^{N} ( {A}_{i} \times {M}_{i ( LS )}^{2} )}{\sum ( {A}_{i} / {M}_{i} ( LS ) )}$$

For a constant elution volume interval ΔVᵢ, where Aᵢ and M_{i(LS)} are the chromatographic peak slice area and polyolefin molecular weight (MW) determined by GPC-MALS respectively associated with the elution volume, Vᵢ.

The corresponded bulk IV(bulk) and bulk M_{w} (bulk) values are calculated in the following way:

$${M}_{w} ( bulk ) = \frac{{Area}_{{LS}_{zero}}}{{Area}_{IR}} * \frac{K ( Mals )}{{( dn / dc )}^{2}}$$

$$IV ( bulk ) = \frac{{Area}_{SpVisc}}{{Area}_{IR} * KIV}$$

Where Area_{IR}, Area_{Lszero} and Area_{SpVisc} are the area of the concentration signal (IR5), the area of the extrapolated LS signal at 0° angle and the area of the specific viscosity. KIV and K(MALS) are the corresponded detector constants.

### GPC Conventional

The column set was calibrated using universal calibration with 19 polystyrene (PS) standards with a narrow molecular weight distribution (MWD) in the range of 0.5 kg/mol to 11 500 kg/mol. The PS standards were dissolved for 30 min at 160° C. The conversion of the polystyrene peak molecular weight to polypropylene molecular weights is accomplished by using the Mark Houwink equation and the following Mark Houwink constants:

$$\begin{matrix}{K}_{PS} = 19 \times {10}^{- 3} mL / g , & {α}_{PS} = 0.655 \\ {K}_{PP} = 19 \times {10}^{- 3} mL / g , & {α}_{PP} = 0.725\end{matrix}$$

A third order polynomial fit was used to fit the calibration data.

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) using the following formulas:

$${M}_{n} = \frac{{\sum }_{i = 1}^{N} {A}_{i}}{{\sum }_{i = 1}^{N} ( {A}_{i} / {M}_{i} )}$$

$${M}_{w} = \frac{{\sum }_{i = 1}^{N} ( {A}_{i} \times {M}_{i} )}{{\sum }_{i = 1}^{N} {A}_{i}}$$

$${M}_{z} = \frac{{\sum }_{i = 1}^{N} ( {A}_{i} \times {M}_{i}^{2} )}{{\sum }_{i = 1}^{N} ( {A}_{i} / {M}_{i} )}$$

$${IV}_{conv} = {K}_{pp} \frac{{\sum }_{i = 1}^{N} ( {A}_{i} \times {M}_{i}^{{α}_{PP}} )}{{\sum }_{i = 1}^{N} {A}_{i}}$$

For a constant elution volume interval ΔVᵢ, where Aᵢ, and Mᵢ are the chromatographic peak slice area and polyolefin molecular weight (MW), respectively associated with the elution volume, Vᵢ.

gpcBR Index

The gpcBR index is calculated by using the following formula:

$${gpc}_{BR} = [ ( \frac{{IV}_{conv}}{IV ( bulk )} ) ] \cdot {[ \frac{{M}_{w} ( bulk )}{{M}_{w}} ]}^{α} - 1$$

All GPC calculation were performed using GPCone Software from PolymerChar. Wyatt, P. J. (1993) Analy. Chim. Acta, Light Scattering and the Absolute Characterisation of Macromolecules. 272, 1-40.

Determination of Grafted Coupling Agent Concentration (α-Linolenic Acid) after Irradiation by ¹H-NMR
1. Soxhlett extraction to remove non grafted coupling agent

2.5 g of the ground sample are weighed into a soxhlett sleeve. In a round flask (250 ml) 200 ml n-hexane are placed, the sleeve is inserted into the soxhlet. Extraction of non grafted coupling agent takes place under reflux cooling over a period of 24 hours. The residue is dried overnight in the vacuum drying oven at 90° C., cooled to room temperature and used for ¹H NAMR spectroscopy method.

2. ¹HNMR spectroscopy method

Quantitative ¹H NMR spectra recorded in the solution-state using a Bruker AVNEO 400 NMR spectrometer operating at 400.15 MHz. All spectra were recorded using a ¹³C optimised 10 mm selective excitation probe head at 125° C. using nitrogen gas for all pneumatics. Approximately 200 mg of material was dissolved in approximately 3 ml 1,2-tetrachloroethane-d₂ (TCE-d₂) using approximately 3 mg of Hostanox 03 (CAS 32509-66-3) as stabiliser. Standard single-pulse excitation was employed utilising a 30 degree pulse, a relaxation delay of 3 s and 10 Hz sample rotation. A total of 64 k data points were collected per FID with a dwell time of 61 ρs, corresponding to a spectral window of approximately 20 ppm. 512 transients were acquired per spectra using 4 dummy scans. This setup was chosen for high sensitivity, resolution and stability with respect to unsaturated species.

Quantitative ¹H spectra were processed applying an exponential window function with 0.3 Hz linebroadning, integrated and relevant ratios determined from the intensities of the integrals. All chemical shifts were indirectly referenced to TMS at 0.00 ppm using the signal resulting from the residual protonated solvent at 5.95 ppm {Resconi L., Cavallo L., Fait A., Piemontesi F., Chem. Rev. 2000, 100, 1253} and the intensity of the aliphatic bulk signal (I_{bulk}) set to 100000. Characteristic signals at specific ¹H NMR chemical shifts corresponding to the presence of the listed structural groups were observed which are summarized in Table 1 {Resconi L., Piemontesi F., Camurati I., Sudmeijer O., Nifantèf I. E., Ivschenko P. V., Kuzmina L. G., J. Am. Soc. 1998, 120, 2308-2321}:

TABLE 1
Characteristic ¹H NMR signals

| | Chemical shift | |
|---|---|---|
| | ¹H NMR | |
| Structural group | [ppm] | Intensity |
| aliphatic bulk | 2.80-(−0.5) | y |
| terminal vinylidene | 4.73-4.66 | w |
| internal vinylidene | 4.85-4.73 | z |
| vinylene | 5.55-5.27 | x |
| allyl isobutenyl | 5.08-4.85 | v |
| hostanox | 7.00-6.81 | h |

Ratios between intensities of specific groups were calculated compensating for influences of other groups:

$$ratio x / z = x / ( z - w )$$

$$ratio x / y = x / ( y - ( h / 4 * 42 ) )$$

Quantification of microstructure by NMR spectroscopy

Quantitative nuclear-magnetic resonance (NMR) spectroscopy was done as described in WO 2022/238520 A1.

Intrinsic viscosity (IV) was measured according to DIN ISO 1628/1, October 1999 (in Decalin at 135° C.).

Melting temperature Tm, crystallization temperature Tc and melting enthalpy Hm

The melting temperature, Tm, was determined by differential scanning calorimetry (DSC) according to ISO 11357-3 with a TA-Instruments 2920 Dual-Cell with RSC refrigeration apparatus and data station. A heating and cooling rate of 10° C./min is applied in a heat/cool/heat cycle between +23 and +210° C. The crystallization temperature (Tc) is determined from the cooling step while melting temperature (Tm) and melting enthalpy (Hm) are being determined in the second heating step.

F₃₀ and F₂₀₀ melt strength and V₃₀ melt extensibility

The test described herein follows ISO 16790:2005. The strain hardening behaviour was determined by the method as described in the article “Rheotens-Mastercurves and Drawability of Polymer Melts”, M. H. Wagner, Polymer Engineering and Science, Vol. 36, pages 925 to 935. The strain hardening behaviour of polymers was analysed by Rheotens apparatus (product of Gottfert, Siemensstr. 2, 74711 Buchen, Germany) in which a melt strand is elongated by drawing down with a defined acceleration.

The Rheotens experiment simulates industrial spinning and extrusion processes. In principle a melt is pressed or extruded through a round die and the resulting strand is hauled off. The stress on the extrudate is recorded, as a function of melt properties and measuring parameters (especially the ratio between output and haul-off speed, practically a measure for the extension rate). For the results presented below, the materials were extruded with a lab extruder HAAKE Polylab system and a gear pump with cylindrical die (L/D=6.0/2.0 mm). For measuring F₃₀ melt strength and v₃₀ melt extensibility, the pressure at the extruder exit (=gear pump entry) is set to 30 bars by by-passing a part of the extruded polymer. For measuring F₂₀₀ melt strength, the pressure at the extruder exit (=gear pump entry) is set to 200 bars by by-passing a part of the extruded polymer.

The gear pump was pre-adjusted to a strand extrusion rate of 5 mm/s, and the melt temperature was set to 200° C. The spinline length between die and Rheotens wheels was 80 mm. At the beginning of the experiment, the take-up speed of the Rheotens wheels was adjusted to the velocity of the extruded polymer strand (tensile force zero): Then the experiment was started by slowly increasing the take-up speed of the Rheotens wheels until the polymer filament breaks. The acceleration of the wheels was small enough so that the tensile force was measured under quasi-steady conditions. The acceleration of the melt strand drawn down is 120 mm/sec². The Rheotens was operated in combination with the PC program EXTENS. This is a real-time data-acquisition program, which displays and stores the measured data of tensile force and drawdown speed. The end points of the Rheotens curve (force versus pulley rotary speed), where the polymer strand ruptures, are taken as the F₃₀ melt strength and v₃₀ melt extensibility values, or the F₂₀₀ melt strength, respectively.

The additional melt strength (AMS) is calculated according to equation (II)

$$AMS = MS ( HMS - PP ) - LMS , \qquad ( II )$$

wherein AMS is the additional F₃₀ melt strength (AMS) determined according to ISO 16790:2005 compared to the F₃₀ melt strength (LMS) of a linear polypropylene having the same melt flow rate MFR₂ (230° C., 2.16 kg) determined according to ISO 1133 as the high melt strength polypropylene (HMS-PP) in [cN], MS(HMS-PP) is the F₃₀ melt strength of the high melt strength polypropylene (HMS-PP) determined according to ISO 16790:2005 in [cN], LMS is the F₃₀ melt strength (LMS) of a linear polypropylene having the same melt flow rate MFR₂ (230° C., 2.16 kg) determined according to ISO 1133 as the high melt strength polypropylene (HMS-PP) in [cN], and the F₃₀ melt strength (LMS) of the corresponding linear polypropylene having the same melt flow rate as the high melt strength polypropylene (HMS-PP) and a polydispersity in the range of 3 to 5 is determined according to equation (III)

$$LMS = 17.35 {MFR}^{- 0.994} , \qquad ( III )$$

wherein MFR is the melt flow rate MFR₂ (230° C., 2.16 kg) determined according to ISO 1133 of the high melt strength polypropylene (HMS-PP).

Equation (III) is the fitting function of the melt flow rate MFR₂ (230° C., 2.16 kg) determined according to ISO 1133 and the F₃₀ melt strength as defined above of commercial linear propylene homopolymers tested by the Rheotens. The melt flow rates and F₃₀ melt strength of said commercial linear propylene homopolymers from Borealis are summarized in Table 2.

TABLE 2
F₃₀ melt strength as a function of the melt flow rate

| | | F₃₀ melt |
|---|---|---|
| Commercial | MFR₂ | strength |
| linear PP | [g/10 min] | [cN] |
| BA390 | 0.2 | 87 |
| BE50 | 0.3 | 60 |
| HA001 | 0.5 | 35 |
| HA507 | 0.9 | 17 |
| HB600TF | 2.0 | 9 |
| HC205TF | 5.0 | 3.5 |
| HD120MO | 10.0 | 1.8 |

### Shear Thinning Index SHI

The characterization of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates using nitrogen atmosphere and setting a strain within the linear viscoelastic regime. The oscillatory shear tests were done at 200° C. applying a frequency range between 0.01 and 300 rad/s and setting a gap of 0.5 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where σ₀, and γ₀ are the stress and strain amplitudes, respectively; ω is the angular frequency; 6 is the phase shift (loss angle between applied strain and stress response); t is the time.

Dynamic test results are typically expressed by means of several different rheological functions, namely the shear storage modulus, G′, the shear loss modulus, G″, the complex shear modulus, G*, the complex shear viscosity, η*, the dynamic shear viscosity, η′, the out-of-phase component of the complex shear viscosity, η″ and the loss tangent, tan η, which can be expressed as follows:

$${G}^{′} = \frac{{σ}_{0}}{{γ}_{0}} cos δ [ Pa ] \qquad ( 3 )$$

$${G}^{″} = \frac{{σ}_{0}}{{γ}_{0}} sin δ [ Pa ] \qquad ( 4 )$$

$${G}^{*} = G ‘ + iG “ [ Pa ] \qquad ( 5 )$$

$${η}^{*} = {η}^{′} - i {η}^{″} [ Pa \cdot s ] \qquad ( 6 )$$

$$η ’ = \frac{{G}^{″}}{ω} [ Pa \cdot s ] \qquad ( 7 )$$

$$η ” = \frac{{G}^{{′}^{′}}}{ω} [ Pa \cdot s ] \qquad ( 8 )$$

The determination of so-called Shear Thinning Index, which correlates with MWD and is independent of Mw, is done as described in equation 9.

$${SHI}_{( 0.05 / 285 )} = \frac{Eta * at 0.05 rad / s}{Eta * at 285 rad / s} \qquad ( 9 )$$

For example, the SHI_{(0.5/285)} is defined by the value of the complex viscosity, in Pa s, determined at a frequency of 0.05 rad/s, divided by the value of the complex viscosity, in Pa s, determined at a frequency of 285 rad/s.

The values of storage modulus (G′), loss modulus (G″), complex modulus (G*) and complex viscosity (η*) were obtained as a function of frequency (ω).

Thereby, e.g. η*_{285rad/s} (eta*_{28s5rad/s}) is used as abbreviation for the complex viscosity at the frequency of 285 rad/s and n*_{0.05rad/s} (eta*_{0.05rad/s}) is used as abbreviation for the complex viscosity at the frequency of 0.05 rad/s.

The loss tangent tan (delta) is defined as the ratio of the loss modulus (G″) and the storage modulus (G′) at a given frequency. Thereby, e.g. tan_{0.05} is used as abbreviation for the ratio of the loss modulus (G″) and the storage modulus (G′) at 0.05 rad/s and tan₂₈₅ is used as abbreviation for the ratio of the loss modulus (G″) and the storage modulus (G′) at 285 rad/s.

The elasticity balance tan_{0.05}/tan₂₈₅ is defined as the ratio of the loss tangent tan_{0.05} and the loss tangent tan₂₈₅.

The polydispersity index, PI, is defined by equation 10.

$$\begin{matrix}PI = \frac{{10}^{5}}{{G}^{′} ( {ω}_{COP} )} , & {ω}_{COP} = ω for (\end{matrix} {G}^{′} = {G}^{′} ’ ) \qquad ( 10 )$$

where ω_{COP} is the cross-over angular frequency, determined as the angular frequency for which the storage modulus, G′, equals the loss modulus, G″.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “Interpolate y-values to x-values from parameter” and the “logarithmic interpolation type” were applied.

### REFERENCES

[1]“Rheological characterization of polyethylene fractions”, Heino, E. L., Lehtinen, A., Tanner J., Seppala, J., Neste Oy, Porvoo, Finland, Theor. Appl. Rheol., Proc. Int. Congr. Rheol, 11th (1992), 1, 360-362.
[2]“The influence of molecular structure on some rheological properties of polyethylene”, Heino, E. L., Borealis Polymers Oy, Porvoo, Finland, Annual Transactions of the Nordic Rheology Society, 1995.
[3]“Definition of terms relating to the non-ultimate mechanical properties of polymers”, Pure & Appl. Chem., Vol. 70, No. 3, pp. 701-754, 1998.

### Inventive Examples

Inventive examples IE1 to IE5 and comparative examples CE1, CE2 were prepared as follows:

### Precursor Materials

As a linear precursor, the linear polypropylene homopolymer HA001 of Borealis was used, having a MFR₂ of 0.6 g/10 min (230° C., 2.16 kg/cm²; ISO 1133), a melting point of 161° C., a crystallization temperature of 116° C., an isotacticity of 97.3% (pentad concentration by ¹³C NMR) produced by slurry process using a Ziegler-Natta catalyst and containing 50 ppm by weight of Irganox 1076 (antioxidant by BASF).

The F₃₀ melt strength of the stabilized powder is 35 cN.

The linseed oil was purchased from Lausitzer Olmuhle Hoyerswerda GmbH and is cold-pressed linseed oil comprising 99 g fats, 23 g monounsaturated fatty acids, 60 g polyunsaturated fatty acids, 15 g saturated fatty acids and 0.22 g protein per 100 mL.

### Compound Preparation

The propylene homopolymer fluff HA001 of Borealis was compounded with 0.25 wt % linseed oil and 0.05 wt % calciumstearate into pellets (PP pellets) on a Prism TSE 24MC twin-screw extruder under nitrogen with a throughput of 10 kg/h and screw speed of 200 rpm. The additives were dosed via a pre-blend or direct dosing to the extruder. The temperature setting of the extruder was 220°.

MFR₂ of the compound containing the linseed oil and calciumstearate used for irradiation trials was 1.0 g/10 min (230° C., 2.16 kg/cm²; ISO 1133).

### Sample Preparation

2 kg of the PP pellets were placed in an aluminium cylinder having a wall thickness of 2 mm and an outer diameter of 100 mm equipped with a safety valve securing a maximum pressure of 0.2 bar. Before irradiation, the cylinder was flushed with nitrogen to reach 200 ppm oxygen in the gas phase in equilibrium using about 70 L N₂/kg PP.

### Electron Beam Irradiation

General procedure of inventive process for IE11-IE5:

The aluminium cylinder containing the PP pellets and a nitrogen atmosphere with a defined O₂ concentration of 200-300 ppm is placed on a belt at 25° C. The cylinder is then moved at a first belt speed Vᵢ passing a 10 MeV electron beam (TT200 from IBA with a beam current of 5 mA) thereby applying a first surface radiation dose to the sample. The belt is then stopped for a specific period of time (reaction time) and then moved backwards with a second belt speed V₂, thereby passing the electron beam again and applying a second surface radiation dose to the sample (see table 1 for exact reaction parameters). Afterwards the cylinder was stored for one hour at a temperature of 60° C. to complete the reaction (deactivation of radicals) before cooling the sample by flushing the cylinder with nitrogen.

### Comparative Examples CE1-CE2

Same procedure as for the inventive examples IE1-IE5 except that the samples are only subjected to one surface radiation dose and then directly stored for one hour at a temperature of 60° C.

For stabilization, each obtained product was compounded with 0.3 wt % Irganox 1010 (antioxidant by BASF) and 0.3 wt % Irgafos 168 (processing stabilizer by BASF) in a Prism TSE 24MC twin-screw extruder with a barrel length L/D of 40 under nitrogen with a throughput of 10 kg/h, screw speed of 300 rpm and a temperature of 220° C.

TABLE 3
Parameters of the process for the inventive examples
IE1-IE5 and comparative examples CE1-CE2.

| | | First | | | Second |
|---|---|---|---|---|---|
| | First | surface | | Second | surface |
| | belt | radiation | Reaction | belt | radiation |
| | speed V₁ | dose | time | speed V₂ | dose |
| Sample | [m min⁻¹] | [kGy] | [min] | [m min⁻¹] | [kGy] |
| IE1 | 0.66 | 91.5 | 2 | 2.99 | 20.3 |
| IE2 | 0.66 | 91.5 | 3 | 2.99 | 20.3 |
| IE3 | 0.66 | 91.5 | 5 | 2.99 | 20.3 |
| IE4 | 0.66 | 91.5 | 10 | 2.99 | 20.3 |
| IE5 | 0.82 | 74.2 | 1 | 1.66 | 36.6 |
| CE1 | 0.54 | 111.8 | 0 | 0 | 0 |
| CE2 | 0.66 | 91.5 | 0 | 0 | 0 |

TABLE 4
Summary of the properties of the obtained inventive and comparative HMS-polypropylenes.

| | Total | | | | | | | | |
|---|---|---|---|---|---|---|---|---|---|
| | surface | | | SHI | Crossover | Crossover | | η* | η* |
| | radiation dose | MFR₂ | | (_{0.05/285)} | point | point Gc | PI | 0.05 | 285 |
| Example | [kGy] | [g/10 min] | gpcBR | [—] | [rad/s] | [kPa] | [Pa⁻¹] | [Pa s] | [Pa s] |
| IE1 | 111.8 | 2.30 | | 61.8 | 9.6 | 8221.1 | 12.2 | 11827 | 191.4 |
| IE2 | 111.8 | 2.15 | 1.26 | 60.0 | 10.8 | 8717.3 | 11.5 | 11502 | 191.7 |
| IE3 | 111.8 | 1.58 | 1.33 | 70.0 | 6.3 | 6797.8 | 14.7 | 13283 | 189.8 |
| IE4 | 111.8 | 1.41 | 1.40 | 73.2 | 5.3 | 6748.4 | 14.8 | 14704 | 200.9 |
| IE5 | 110.8 | 1.85 | | 68.2 | 6.6 | 7197.5 | 13.9 | 13500 | 197.9 |
| CE1 | 111.8 | 3.57 | 1.05 | 52.0 | 16.9 | 9934.4 | 10.1 | 9476 | 182.2 |
| CE2 | 91.5 | 2.45 | | 55.6 | 12.3 | 11008 | 9.1 | 12561 | 225.9 |

| | Tan | F₃₀ | F₂₀₀ | Phase | | Tₘ | Tₘ | Hₘ | |
|---|---|---|---|---|---|---|---|---|---|
| | delta | melt | melt | Angle | | first | second | second | |
| | at 0.1 | strength | strength | at | V₃₀ | heat | heat | heat | T_{c} |
| Example | rad/s | [cN] | [cN] | G*1000 | [mm/s] | [° C.] | [° C.] | [J/g] | [° C.] |
| IE1 | 1.5 | 29.8 | 27.2 | 56.5 | 260 | 161 | 159 | 103 | 122.5 |
| IE2 | 1.6 | 26.1 | 25.7 | 57.0 | 262 | 162 | 159.5 | 99 | 123.0 |
| IE3 | 1.4 | 31.0 | 28.9 | 54.9 | 258 | 162 | 159.5 | 101.5 | 122.6 |
| IE4 | 1.4 | 31.3 | 29.9 | 54.4 | 263 | 162 | 159.5 | 101.7 | 123.0 |
| IE5 | 1.4 | 28.9 | 26.7 | 55.1 | 256 | | | | |
| CE1 | 1.8 | 24.7 | 23.6 | 59.1 | 267 | 163 | 159.5 | 99 | 122.4 |
| CE2 | 1.8 | 26.0 | 23.1 | 60.3 | 256 | | | | |

TABLE 5
Summary of the molar properties of the obtained inventive
and comparative HMS-polypropylenes IE2-IE4 and CE1.

| | | | | Bulk | | |
|---|---|---|---|---|---|---|
| Exam- | M_{N} | M_{w} | M_{z} | M_{w} | IV | |
| ple | [g/mol] | [g/mol] | [g/mol] | [g/mol] | (Bulk) | PDI |
| IE2 | 2.92*10⁴ | 7.38*10⁵ | 4.58*10⁶ | 7.40*10⁵ | 1.269 | 25.27 |
| IE3 | 2.48*10⁴ | 7.52*10⁵ | 4.54*10⁶ | 7.62*10⁵ | 1.257 | 30.32 |
| IE4 | 3.05*10⁴ | 8.01*10⁵ | 5.52*10⁶ | 8.01*10⁵ | 1.266 | 26.26 |
| CE1 | 2.86*10⁴ | 5.90*10⁵ | 3.32*10⁶ | 5.89*10⁵ | 1.192 | 20.63 |

As can be gathered from Table 4, the HMS-PP IE1-IE5 obtained by the inventive process show a higher F₃₀ and F₂₀₀ melt strength compared to the CE1 and CE2 with only one irradiation period. Further, a lower MFR₂ and higher gpcBR of the inventive examples show that a higher degree of branching is achieved. A higher shear hardening index (SHI) is also achieved.

1: A process for producing a high melt strength polypropylene (HMS-PP), comprising steps in the following order:
a) providing a linear propylene polymer (L-PP),
a1) optionally blending said propylene polymer (L-PP) with a coupling agent (CA) comprising a polyunsaturated organic compound, and
b) irradiating the L-PP provided in step a) or the blend obtained in step a1) by means of electron beam irradiation,
wherein step b) comprises at least two irradiation periods, and
wherein between each irradiation period is a period of no irradiation, and
wherein each period of no irradiation is in the range of 0.01 min to 20 min.

2: The process according to claim 1, wherein in step b) the applied surface radiation dose in the first of the at least two irradiation periods is in the range of 10 to 150 kGy;
and/or the applied surface radiation dose in the second of the at least two irradiation periods is in the range of 5 kGy to 150 kGy;
and/or wherein the ratio between the applied surface radiation dose in the first of the at least two irradiation periods and the applied surface radiation dose in the second of the at least two irradiation periods is in the range of more than 1.1 to 30;
and/or wherein the total applied surface radiation dose in the process is in the range of 30 kGy to 200 kGy.

3: The process according to claim 1, wherein the process comprises step a1) and the blend obtained in step a1) comprises 0.01 to 5.0 wt % of the coupling agent (CA) comprising a polyunsaturated organic compound, based on the overall weight of the blend obtained in step a1);
and/or wherein the amount of polyunsaturated organic compound in the coupling agent (CA) comprising a polyunsaturated organic compound is in the range of 20 wt % to 100 wt %;
and/or the coupling agent (CA) comprising a polyunsaturated organic compound is selected from the group consisting of linseed oil, walnut oil, tung oil and sunflower oil.

4: The process according to claim 1, wherein the maximum pressure in the process does not exceed 0.2 bar;
or wherein the pressure in the process is more than 0.2 bar.

5: The process according to claim 1, wherein the process comprises after step b) a further step c), wherein step c) comprises a tempering period, wherein the irradiated L-PP or irradiated blend obtained in step b) is tempered at a temperature in the range of 40 to 140° C.;
and/or the tempering period in step c) is in the range of 5 min to 120 min.

6: The process according to claim 1, wherein the electron beam for the electron beam irradiation is an electron beam having an acceleration voltage in the range of 5 MeV to 15 MeV.

7: The process according to claim 1, wherein step b) consists of two irradiation periods and in between of a period of no irradiation wherein the period of no irradiation is in the range of 0.01 min to 20 min.

8: The process according to claim 1, wherein the L-PP provided in step a) or the blend obtained in step a1) is placed inside a sealable containment before irradiation in step b).

9: The process according to claim 8, wherein the sealable containment containing the L-PP provided in step a) or containing the blend obtained in step a1) is flushed with nitrogen until an atmosphere having oxygen in an amount in the range of 1 to 1000 ppm inside the containment is reached.

10: The process according to claim 1, wherein the process comprises after step b) or step c) a further step d), wherein step d) comprises homogenizing the irradiated L-PP or irradiated blend obtained in step b) or step c).

11: The process according to claim 10, wherein additives (AD) can be added to the irradiated L-PP or irradiated blend obtained after step b) or step c) before or during the homogenization in step d); and/or
wherein additives (AD) are applied to the surface of the homogenized irradiated L-PP or homogenized irradiated blend obtained after step d).

12: A high melt strength polypropylene (HMS-PP) comprising units derivable from:
i) propylene, and
ii) at least one polyunsaturated fatty acid,
wherein the high melt strength polypropylene (HMS-PP) has a crystallization temperature Tc determined according to DSC of more than 120° C., and
wherein the F₃₀ melt strength by Rheotens measurement according to ISO 16790:2005 at 200° C., acceleration of 120 mm/s, at standard shear (die pressure 30 bar) is more than 26 cN,
the melt flow rate MFR₂ (230° C., 2.16 kg) determined according to ISO 1133 is in the range of 1.0 to 2.4 g/10 min, and wherein
the complex shear viscosity η* at a frequency of 285 rad/s, determined by dynamic shear measurements complying with ISO standards 6721-1 and 6721-10, is more than 170 Pa s.

13: The high melt strength polypropylene (HMS-PP) according to claim 12, wherein the HMS-PP is obtained by:
a) providing a linear propylene polymer (L-PP),
a1) optionally blending said propylene polymer (L-PP) with a coupling agent (CA) comprising a polyunsaturated organic compound, and
b) irradiating the L-PP provided in step a) or the blend obtained in step a1) by means of electron beam irradiation,
wherein step b) comprises at least two irradiation periods, and
wherein between each irradiation period is a period of no irradiation, and
wherein each period of no irradiation is in the range of 0.01 min to 20 min.

14: An article comprising the high melt strength polypropylene (HMS-PP) according to claim 12.

15: A method of using the high melt strength polypropylene (HMS-PP) according to claim 12 for foam applications, including extrusion foam, bead foam, injection moulding foam or coating foam.
